(19) United States
(12) Patent Application Publication
(10) Pub. No.: US 2021/0114646 A1
(43) Pub. Date: Apr. 22, 2021

(54) SUITCASE AND HAND TRUCK FOR ASCENDING AND DESCENDING STAIRS

(71) Applicant: Tadao Hashimoto, Santa Barbara, CA (US)

(72) Inventor: Tadao Hashimoto, Santa Barbara, CA (US)

(21) Appl. No.: 17/067,757

(22) Filed: Oct. 11, 2020

Related U.S. Application Data
(60) Provisional application No. 62/916,227, filed on Oct. 17, 2019.

(51) Int. Cl. B62B 5/02

(52) U.S. Cl. CPC B62B 5/02

(57) ABSTRACT

The present invention discloses a load-carrying device such as a suitcase, a carry-bag and a hand truck, which can ascend and descend stairs without changing the position of the person relative to the device. The load-carrying device is constructed with a main frame which defines a main plane of the device, at least two main wheels, and a support frame which can swing out of the main plane. The support frame is equipped with a caterpillar mechanism and optional bottom wheels. When ascending stairs, the support frame is pushed against the main frame by the edge of the stairs and the caterpillar with a ratchet mechanism helps slide the load-carrying device upward. When descending stairs, the support frame swings down toward the lower step before the main wheels go off the upper step so that the support frame enables soft-landing of the main wheels.

### CROSS REFERENCE TO RELATED APPLICATIONS

This application claims the benefit of priority to inventor Tadao Hashimoto's U.S. provisional patent application No. 62/916,227 filed Oct. 17, 2019 entitled “A suitcase and a hand truck which can ascend and descend stairs”, the contents of which are incorporated herein by reference in their entirety for all purposes.

### BACKGROUND OF THE INVENTION

### Field of the Invention

This invention provides a load-carrying device such as a suitcase, a caster bag, a roller case, a hand truck used for personal use and industrial use.

### Description of the Existing Technology

A load-carrying device such as a suitcase, a caster bag, a roller case, and a hand truck, is widely used by travelers and movers. Also, a wheel chair and a rolling bed used in medical environment are also regarded as a load-carrying device for purposes of this invention. A load-carrying device typically has multiple wheels at the bottom so that it can be rolled on a flat surface. However, the majority of such devices can not go upstairs or downstairs. So, when a person walks on the stairs, the device and the load must be carried together.

Some technologies were developed to solve this problem. There are two solutions. The first way is to have very large wheels or combination of wheels (i.e. three wheels separated by 120 degree located on a larger diameter circle). The diameter of the wheel is comparable or larger than the step size. This way, the device can overcome the height difference of the steps. The second method uses an additional slider or a wheel such as a caterpillar mounted on a frame. These two techniques can solve going upstairs, but do not necessarily help go downstairs. Also, the current solutions require a person to change the position from pulling to pushing when going downstairs. For safety reasons, it is preferable to have the load carrying devices behind the person when going downstairs so that the device can be caught even if the person accidentally releases his/her hand while going down. If the person is pushing down the device while descending stairs, the device can slide down out of control if the person accidentally releases a hand.

### BRIEF SUMMARY OF THE INVENTION

The present invention provides a load-carrying device such as a suitcase and a hand truck which can go up and down stairs without changing the position of the person relative to the device. A person pulls the load-carrying device all the time. The load-carrying device is constructed with a main frame which defines a main plane of the device, at least two main wheels, and a support frame which can swing out of the main plane. The support frame is equipped with a caterpillar mechanism and optional bottom wheels. When ascending stairs, the support frame is pushed against the main frame by the edges of the stairs, and the caterpillar mechanism helps slide the load-carrying device upward. When descending stairs, the support frame swings down toward the lower step before the main wheels go off the upper step so that the support frame helps soft-land the main wheels. The support frame can be equipped with a shock-absorbing mechanism for smoother movement of the device, if desired. The main wheels may optionally have a shock-absorbing mechanism for smoother movement of the device. Also, the pulling handle of the device can optionally be retractable and the retraction/extraction of the support frame can be linked to the handle retraction/extraction.

### BRIEF DESCRIPTION OF THE DRAWINGS

Referring now to the drawings in which like reference numbers represent corresponding parts throughout:

FIG. 1 is one example of a load-carrying device.

In the figure each number represents the following:
100. A suitcase shell of the load-carrying device
101. A main frame,
102. Main wheels,
103. A support frame,
103A. A caterpillar slider,
103B. A support wheel,
104. A handle,
105. A cover for the support frame,
106. A shock-absorbing mechanism.

FIG. 2 is one example of a load-carrying device with the handle retracted.

In the figure each number represents the following:
200. A suitcase shell of the load-carrying device,
201. A main frame,
202. Main wheels,
203. A support frame,
204. A handle,
205. A cover for the support frame,
206. A shock-absorbing mechanism.

FIG. 3 is a side view of the load-carrying device while ascending the stairs.
300. A suitcase shell of the load-carrying device,
302. Main wheels,
303A. A caterpillar slider,
304. A handle,
310. The slope of the stairs,
311. The main plane,

FIG. 4 is a side view of the load-carrying device descending the stairs.
400. A suitcase shell of the load-carrying device,
402. Main wheels,
403. A support frame,
403B. A support wheel,
404. A handle,
406. A shock-absorbing mechanism,
410. The slope of the stairs,
411. The main plane.

FIG. 5(a) and FIG. 5(b) provide different views of one example of a load-carrying device. FIG. 5(a) is a bird-eye view and FIG. 5(b) is a front view.

In the figure each number represents the following:
500. A suitcase shell of the load-carrying device
501. A main frame,
502. Main wheels,
503. A support frame,
503A. A caterpillar slider,
503B. A support wheel,
504. A handle,
505. A cover for the support frame,
506. A shock-absorbing mechanism,
507. A pair of support hinge dampers.

FIG. 6(a)-FIG. 6(c) depict various embodiments of shock-absorbing mechanisms. FIG. 6(a) is a support hinge damper, FIG. 6(b) is a hydraulic damper, and FIG. 6(c) is a spring damper. In each figure, the arrow indicates the direction of damper action.

In each figure each number represents the following:
601. A main frame,
602. Main wheels,
603. A support frame,
603B. A support wheel,
606. A shock-absorbing mechanism,
607A. A support hinge damper,
607B. A hydraulic damper,
607C. A spring damper.

FIG. 7(a)-FIG. 7(b) illustrate examples of ratchet mechanisms for the caterpillar. FIG. 7(a) is a ratchet with a stopper that engages the wheel, and FIG. 7(b) is a ratchet with a stopper that engages the caterpillar surface. In the figure, the arrow indicates the direction of rotation.

In each figure each number represents the following:
721. A caterpillar band,
722. End wheels,
723. A directional gear,
724. A stopper pin,
725. A torsion spring,
726. A middle wheel,
727. A caterpillar supporting plate.

FIG. 8(a)-FIG. 8(c) provide various embodiments of shock-absorbing mechanisms for main wheels in which FIG. 8(a) is a mechanism using axle elastic bend motion, FIG. 8(b) is a mechanism using axle torsion, and FIG. 8(c) is a mechanism using additional springs and dampers.

In each figure each number represents the following:
801. A main frame,
802. Main wheel,
808. Axle,
809. A swing plate for a torsion axle, and
830. Additional spring and damper for that wheel and axle.

### DETAILED DESCRIPTION OF THE INVENTION

The load-carrying device in this invention has a main frame which defines a main plane, a pulling handle, at least two main wheels mechanically connected to the main frame, and a support frame mechanically connected to the frame structure. The support frame can swing in and out of the main plane and performs two functions; (1) helping the device slide up steps when ascending stairs and (2) helping the main wheels soft-land the lower step when descending stairs.

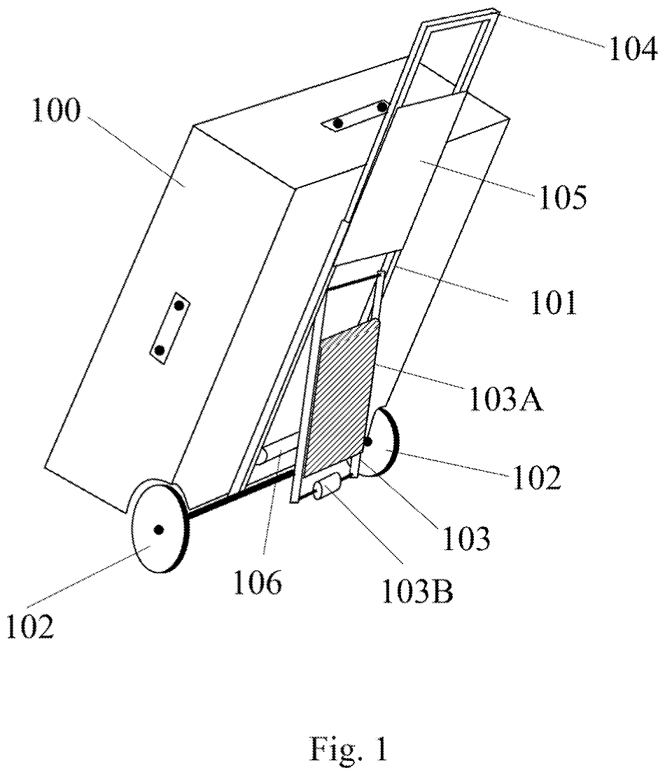

FIG. 1 shows one example of the load-carrying device in this invention. This device is a suitcase with a shell 100 which is attached to a main frame 101. Two main wheels 102 and a support frame 103 are mechanically attached to the main frame 101. As shown in the figure, the support frame 103 can swing out of the main plane defined by the main frame 101. The support frame 103 has a caterpillar 103A which helps the suitcase slide upstairs. Also, the support frame 103 has an additional wheel 103B, which helps the main wheels 102 soft-land the lower step when going downstairs. There is a shock-absorbing mechanism 106 on the main frame 101. As explained later with FIG. 4, when the support frame 103 swings back against the main frame 101, the support frame 103, the caterpillar 103A, and/or the additional wheel 103B hit the shock-absorbing mechanism 106 and stops. In addition to the shock-absorbing mechanism 106 shown in the figure, the device can have other shock-absorbing mechanism using a hydraulic, gas or friction mechanism including hydraulic dampers, gas dampers, spring dampers, rotary dampers, and support hinge dampers in order to reduce the impact of the support frame 103 against the main frame 101.

A person pulls the handle 104 when going on a smooth path, ascending stairs and descending stairs. On the handle posts there is a cover plate 105 which covers a part or all of the support frame 103.

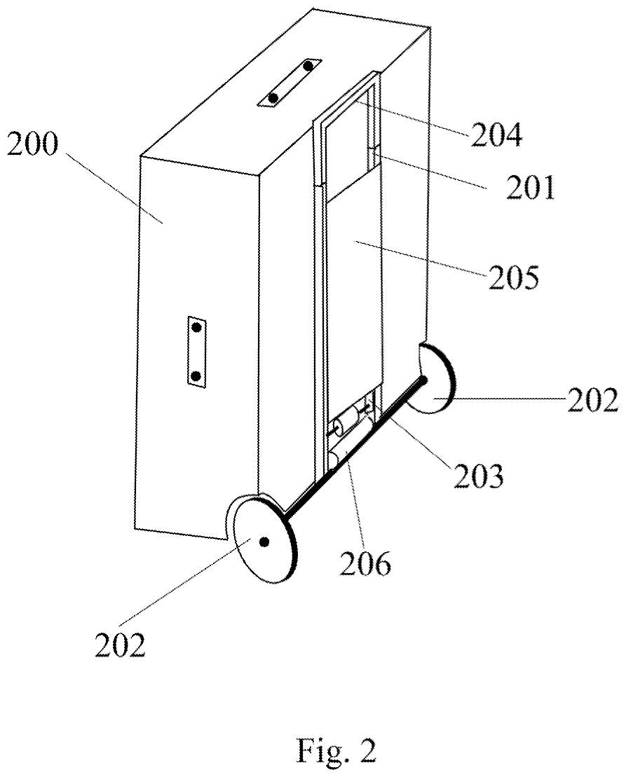

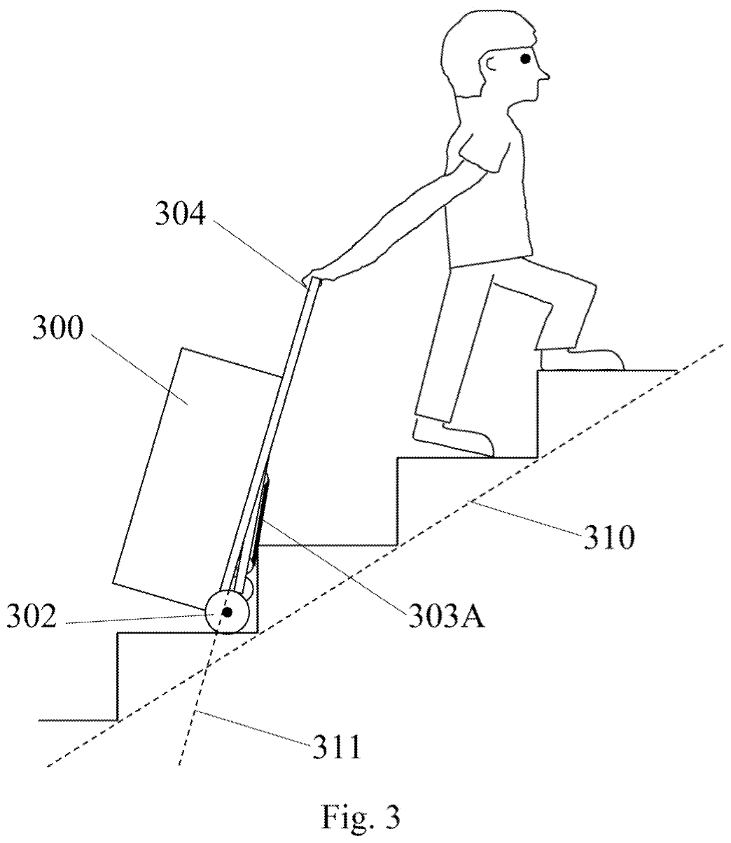

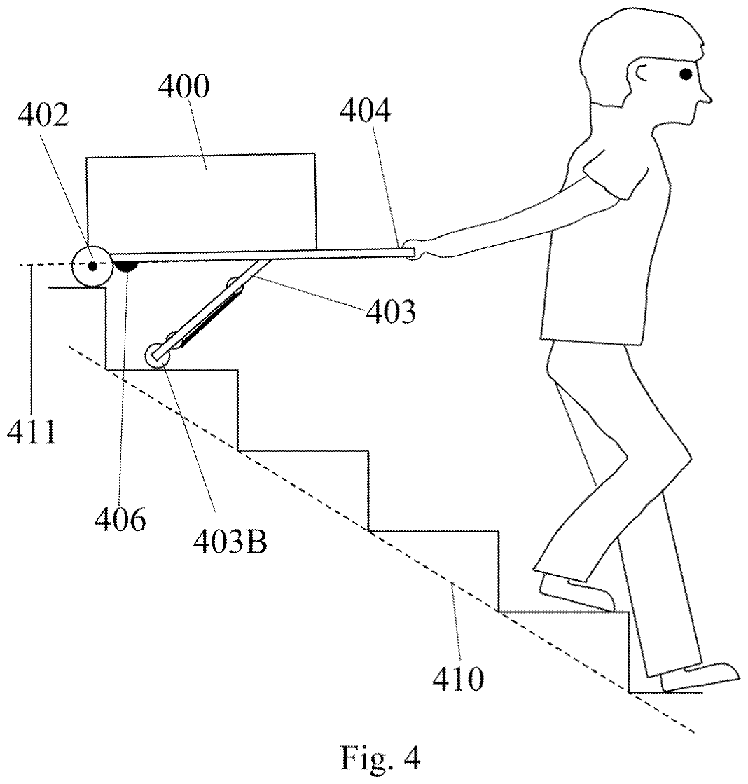

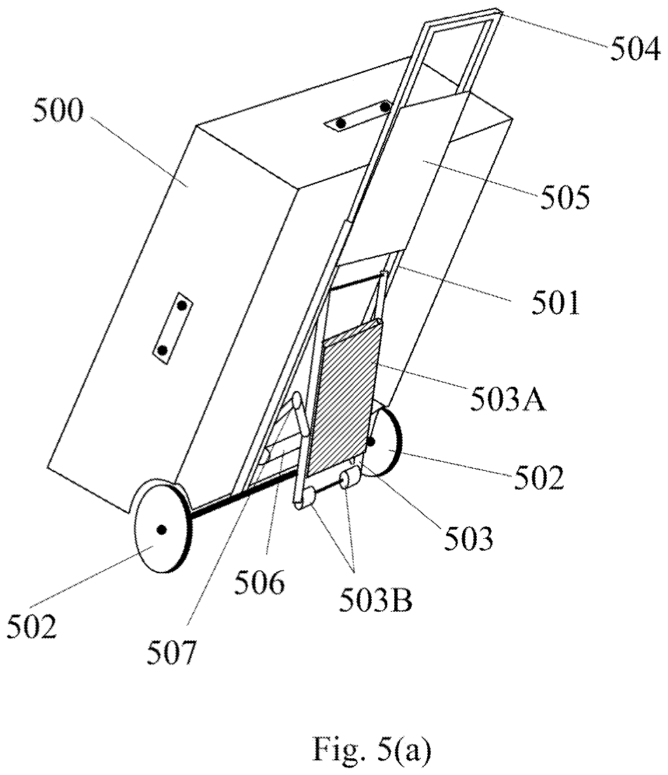

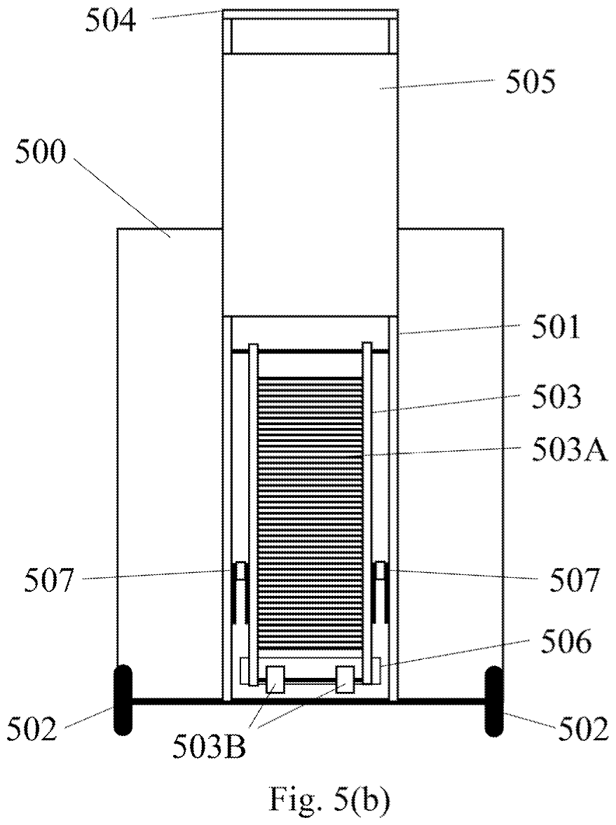

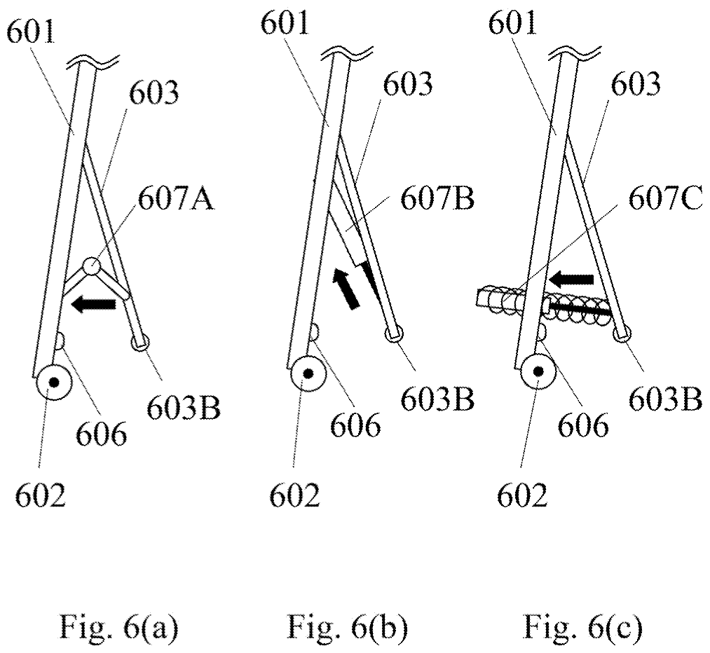

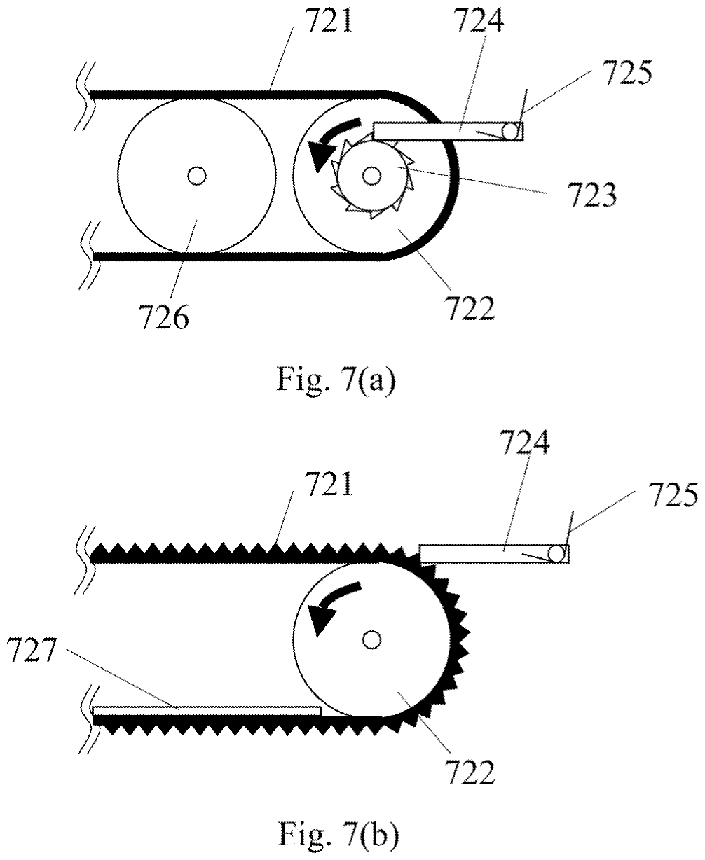

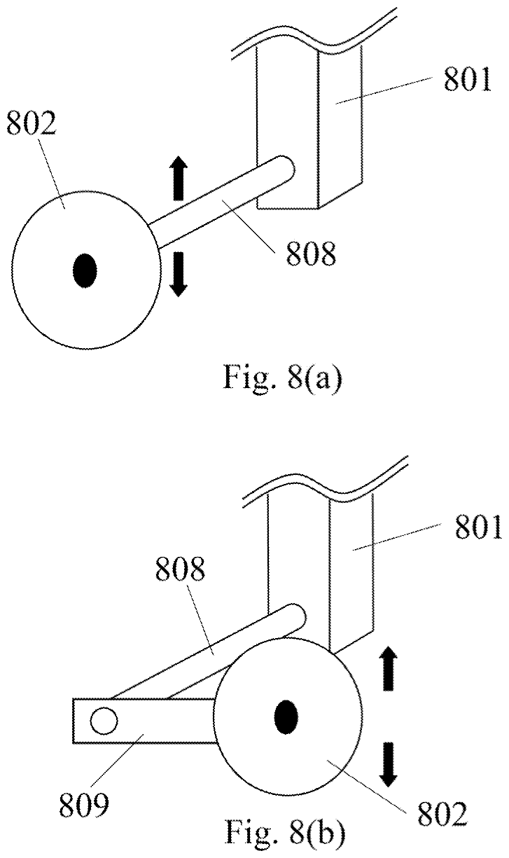

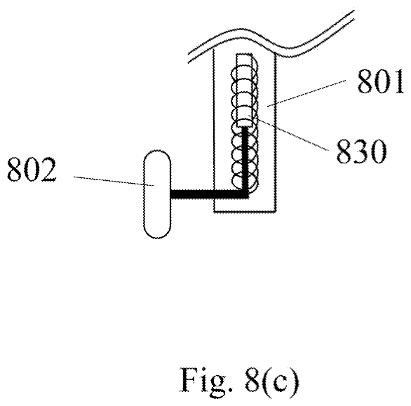

FIG. 2 shows the configuration where the handle of the suitcase is retracted. When the handle 204 is retracted, the cover plate 205 shifts with the handle bar and covers a part of the support frame 203. Although FIG. 2 shows an example with a cover plate which covers a part of the support frame, the cover plate can also cover the entire support frame. The shock-absorbing mechanism 206 is also linked with the handle motion. When the handle is retracted, the shock-absorbing mechanism slides down so that it does not interfere with the support frame 203.

FIG. 3 shows the configuration of pulling the suitcase 300 upstairs. The caterpillar 303A touches the edge of a step. When the pulling handle 304 is pulled up, the caterpillar 303A rotates forward direction to help the suitcase 300 go up the step. The caterpillar 303A optionally has a ratchet mechanism so that it prevents the suitcase 300 from sliding down stairs. Note that the slope of the main plane 311 defined by the main frame has an angle from the slope of the stairs 310. This enables a person to pull the suitcase without changing the posture much. If the slope of the main plane 311 becomes parallel to the slope of the stairs 310 (in such situation, the suitcase most likely lies on the stairs), the handle 304 touches the stairs; therefore a person must lower his/her body to keep holding the handle. This change in posture is not only tiring but also dangerous. After the main wheels climb up one step, the suitcase hits the next step; however since the caterpillar 303A is supported by the shock-absorbing mechanism (not shown in FIG. 3 but shown in FIG. 4's feature 406), the impact by the edge of the step is effectively absorbed.

FIG. 4 shows the configuration of pulling the suitcase 400 downstairs. Note that the person does not change posture to go downstairs. In this situation, the main plane 411, defined by the main frame becomes almost level. When the main wheels 402 proceeds towards the edge of the step, the support frame 403 goes off the step first, touches the lower step before the main wheels 402 go off the step. When the main wheels 402 go off the step, the support frame 403 swings back to the main frame and the additional wheel 403B hits the shock-absorbing mechanism 406. Additionally, the device can have other shock-absorbing mechanism using a hydraulic, gas or friction mechanism including hydraulic dampers, gas dampers, spring dampers, rotary dampers, and support hinge dampers in order to reduce the impact of the support frame 403 against the main frame. This motion enables soft-landing of the main wheels 402 on the lower step.

The main frame which gives shape or support for the load-carrying device may be, for example, a single metal piece such as a backbone and optional additional pieces such as one or more ribs or lips to support the load; an X- or T- or I-shaped piece that likewise supports the load; or a framework having a shape that is generally circular, triangular, or quadrilateral in profile. The support frame also provides shape or support for the load-carrying device. It too may have any of the configurations specified above for the main frame.

Any form of roller may be used, such as a wheel (cylindrical or spherical, for example), caterpillar, tractor (e.g. a caterpillar driven by a motor), etc., and a roller may have a fixed relationship with its respective frame or may be pivotable as provided by e.g. a caster, hinge or other form of pivot.

As explained above, the load-carrying device in this invention enables a person to pull the device all the time without changing his/her posture match. This allows easier moving of a load on upward stairs and downward stairs.

### Example 1

One example of a suitcase is presented in FIG. 5(a) and FIG. 5(b). In each figure, a main frame 501 is made of steel pipes with a telescoping mechanism to incorporate the pulling handle 504. An axle for the main wheels 502 is secured to (e.g. welded on) the frame structure and wheels with ball bearings are bolted on both ends of the axle. The axle is made of a spring alloy steel (e.g. alloy 5160, 1095, 1080, 1070, etc.) so that the shock on the main wheels 502 can be absorbed. The support frame 503 has a rubber caterpillar 503A with multiple cylindrical wheels bolted on a frame of the support frame 503 underneath the caterpillar 503A. This caterpillar 503A is optionally equipped with a ratchet mechanism as explained later, so that a band or tractor tread of the caterpillar only turns towards forward direction. This ratchet helps to prevent the load from slipping backward as a person pulls the load-carrying device up stairs. Additional wheels 503B are attached at the bottom of the support frame 503. The top of the support frame is secured (e.g. bolted) on the main frame 501. The support frame 503 is also linked to the main frame 501 in this particular example with a pair of support hinge dampers 507. Alternatively, other shock absorbing mechanisms can be used as shown in FIG. 6(a)-FIG. 6(c). Support hinge dampers or rotary dampers, as shown in FIG. 6(a), hydraulic or gas dampers, as shown in FIG. 6(b), or spring dampers, as shown in FIG. 6(c) can be used. The main frame 501 can also or instead be equipped with a shock-absorbing polymer or gel block 506, which receives the impact of the additional wheel on the support frame. This shock-absorbing polymer or gel block 506 is, in this particular instance, attached to a metal plate which can slide down when the handle 504 is retracted. In this way, the shock-absorbing mechanism 506 stays away from the additional wheels 503B on the support frame 503, enabling the support frame 503 to retract by having the cover 505 push against the support frame 503 or retract into the (e.g. plastic) cover 505 attached to the handle rods 504 (See FIG. 5(a) and FIG. 5(b)).

As shown in FIG. 5(b), there is optionally a pair of support hinge dampers 507 linking the main frame 501 and the support frame 503. The support hinge dampers may provide damper motion only along one direction, as shown in FIG. 6(a). When the support frame 603 drops down to deploy for use, the support hinge dampers 607A do not resist the support frame's movement away from the main frame 601. On the other hand, when the support frame 603 moves toward the main frame 601, as indicated with an arrow in FIG. 6(a), the support hinge dampers 607A resist motion and slow down the movement of the support frame 603 toward the main support frame 601 (i.e. shows a damper motion) This way, the impact of the support frame 603 on the main frame 601 may be reduced in addition to providing needed support as the load-carrying device ascends or descends stairs.

As shown in FIG. 6(b) and FIG. 6(c), the above-mentioned support hinge dampers can be replaced with hydraulic or gas dampers (FIG. 6(b)) or spring dampers (FIG. 6(c)). These dampers may dampen motion only when the support frame 603 moves toward the main frame 601, as indicated with arrows in FIG. 6 (b) and FIG. 6(c).

FIG. 7(a)-FIG. 7(b) illustrate possible ratchet mechanisms for a caterpillar. A caterpillar band 721 is supported by an end wheel 722 at each end of the caterpillar band and optionally by one or more middle wheels 726 (FIG. 7(a)) or a support plate 727 (FIG. 7(b)). As shown in FIG. 7(a), a directional gear 723 can be attached to at least one wheel. A stopper pin 724 with a torsion spring 725 prevents the directional gear 723 from rotating freely in one direction and therefore allows free rotation in the other direction. A directional gear can be attached to other support wheels such as middle wheel 726(a) instead of or in addition to being present on one or both end wheels. The support wheels 603B may instead or also have a directional gear and stopper pin to limit free wheel rotation to only one direction. Also, instead of using the directional gear, a stopper pin 724 can touch the caterpillar band directly so that the band rotates freely in only one direction (FIG. 7(b)). In this case, the caterpillar band can optionally have higher roughness or a pattern of ribs (parallel and perpendicular to the rotational direction, zig zag, or other configuration) on the surface to ensure stopping action by the stopper pin 724, as shown in FIG. 7(b).

FIG. 8(a)-FIG. 8(c) illustrate examples of shock absorbers on main wheels. The arrows in the figure indicate the generally vertical motion of main wheels. As explained above, the axle 808 can be made of e.g. spring steel and use elastic bending motion to absorb impacts on the wheels 802 (FIG. 8(a)). Alternatively, the main wheels 802 can use a torsion suspension as shown in FIG. 8(b). In this case, the wheel 802 is fixed to a swing plate 809 that is fixed to a torsion axle 808. Also, the main wheel can have a more sophisticated suspension system much like an automobile has by utilizing a spring and damper on each wheel and axle that limit generally vertical motion, as shown in FIG. 8(c).

### Example 2

One example of a hand truck can be constructed by removing a shell from the suitcase in Example 1. Instead of the shell structure, the hand truck can have a bottom plate welded on the main frame so that loads can be placed on it.

Consequently, the following are nonlimiting examples of the invention:
1. A movable load-carrying device having a main frame which defines a main plane, a pulling handle, at least two main wheels mechanically connected to the main frame, and a support frame mechanically connected to the main frame wherein:
   (a) the support frame has a pivot configured to allow the support frame to swing out of the main plane;
   (b) the support frame has a roller configured to contact stairs and support at least a portion of the weight of the load-carrying device when ascending the stairs; and
   (c) the roller of the support frame is configured to contact the stairs and support at least a portion of a weight of the load-carrying device when descending the stairs by swinging down toward and contacting a lower step of the stairs to help soft-land the main wheels before the main wheels lose contact with an upper step of the stairs.
2. A load-carrying device according to paragraph 1, wherein the support frame has a weight sufficient to cause the support frame to pivot as the load-carrying device descends the stairs.
3. A load-carrying device according to paragraph 1 or paragraph 2, wherein the roller comprises a caterpillar mechanism which comprises a continuous track and rollers that support the continuous track.
4. A load-carrying device according to paragraph 3, wherein the support frame also has a wheel at the bottom of the support frame.
5. A load-carrying device according to any of paragraphs 1 through 4, wherein the load-carrying device comprises a shock-absorber that engages the support frame and the main frame.
6. A load carrying device according to paragraph 5, wherein the shock absorber comprises a shock-absorbing polymer or a gel.
7. A load carrying device according to paragraph 5, wherein the shock absorber is a hydraulic, pneumatic or friction shock absorber.
8. A load-carrying device according to any of paragraphs 3 through 7, wherein the caterpillar rotation has a ratchet configured to allow rotation in an ascending direction and prevent rotation in a descending direction.
9. A load-carrying device according to any of paragraphs 1 through 9, wherein the main wheels have a shock absorber.
10. A load-carrying device according to any paragraphs 1 through 10, wherein the pulling handle is retractable and a part or all of the support mechanism is retracted by retracting the handle.
11. A load-carrying device according to any of paragraphs 1 through 10, wherein the load-carrying device is a suitcase having a shell attached to the main frame.
12. A load-carrying device according to any of paragraphs 1 through 10, wherein the load-carrying device is a hand truck having a load support platform connected to the main frame.
13. A load-carrying device according to any of paragraphs 1-12, wherein the device has a weight that can be pulled by a person.
14. A method of making a movable load-carrying device comprising joining a main frame for carrying a load and a support frame through a pivot, and providing a plurality of rollers on the main frame and at least one roller on the support frame, wherein the support frame lies in a main plane defined by the main frame in a non-deployed position for the support frame in which the support frame provides no support for the load of the load-carrying device, and the support frame is outside the main plane in a deployed position in which the support frame provides support for the load of the load-carrying device.
15. A method of supporting a load upon a main frame of a movable load-carrying device comprising distributing a weight of the load through the main frame and rollers attached to the main frame in a first vertical position for the load-carrying device, and supporting the load upon the main frame and a rollable support frame of the movable load-carrying device in a second, inclined or horizontal position for the load-carrying device, wherein the load is not supported by a roller of the rollable support frame in the first vertical position.
16. A method according to paragraph 15, wherein the load is supported by the rollable support frame as the load-carrying device rolls up and down stairs.

### Possible Modifications

Although the preferred embodiment describes a main frame made of steel pipes, other materials such as stainless steels, aluminum alloys, copper alloys, etc. can be used. Also the pipe can be round, square, rectangular or other polygon shape.

Although the preferred embodiment describes a load-carrying device with two main wheels, more than two main wheels can be used.

Although the preferred embodiment describes a support frame with a caterpillar, other sliding mechanism such as a solid bar, ski-like structure can also be used.

Although the preferred embodiment describes one additional wheel on the support frame, it can have more wheels. Also, the wheel can be replaced with the caterpillar.

Any of the wheels may be attached to a rigid axle. Alternatively or additionally, any of the wheels may be attached via pivoting casters.

Although the preferred embodiment describes a load-carrying device with one support frame, multiple support frames can be attached to the main frame depending on the size of the device.

Although the preferred embodiment describes combination of shock-absorbing polymer or gel block and support hinge dampers for the shock-absorbing mechanism, other mechanism such as hydraulic dampers, gas dampers, spring dampers, and rotary dampers can be used. A load-carrying device may be any of the foregoing specifically-mentioned devices or may be any other device that embodies the features specified in the claims.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1-20. (canceled)

21. A movable load-carrying device having a main frame which defines a main plane, a pulling handle, at least two main wheels mechanically connected to the main frame, and a support frame mechanically connected to the main frame wherein:
(a) the support frame has a pivot configured to allow the support frame to swing out of the main plane;
(b) the support frame has one or more sliders configured to contact stairs and support at least a portion of the weight of the load-carrying device when ascending the stairs.

22. A movable load-carrying device in claim 21, wherein the said sliders are configured to contact the stairs and support at least a portion of a weight of the load-carrying device when descending the stairs by swinging down toward and contacting a lower step of the stairs to help soft-land the main wheels before the main wheels lose contact with an upper step of the stairs.

23. A movable load-carrying device in claim 21, wherein the said support frame has one or more additional support wheels configured to contact the stairs and support at least a portion of a weight of the load-carrying device when descending the stairs by swinging down toward and contacting a lower step of the stairs to help soft-land the main wheels before the main wheels lose contact with an upper step of the stairs.

24. A load-carrying device according to claim 22, wherein the support frame has a weight sufficient to cause the support frame to pivot as the load-carrying device descends the stairs.

25. A load-carrying device according to claim 23, wherein the support frame has a weight sufficient to cause the support frame to pivot as the load-carrying device descends the stairs.

26. A load-carrying device according to claim 21, wherein the one or more sliders comprise a caterpillar mechanism which comprises a continuous track and rollers that support the continuous track.

27. A load-carrying device according to claim 22, wherein the load-carrying device comprises a shock-absorber that engages the support frame and the main frame.

28. A load carrying device according to claim 27, wherein the shock absorber comprises a shock-absorbing polymer or a gel.

29. A load carrying device according to claim 27, wherein the shock absorber is a hydraulic, pneumatic or friction shock absorber.

30. A load-carrying device according to claim 23, wherein the load-carrying device comprises a shock-absorber that engages the support frame and the main frame.

31. A load carrying device according to claim 30, wherein the shock absorber comprises a shock-absorbing polymer or a gel.

32. A load carrying device according to claim 30, wherein the shock absorber is a hydraulic, pneumatic or friction shock absorber.

33. A load-carrying device according to claim 26, wherein the caterpillar has a ratchet configured to allow rotation in an ascending direction and prevent rotation in a descending direction.

34. A load-carrying device according to claim 21, wherein the main wheels have a shock absorber.

35. A load-carrying device according to claim 21, wherein the pulling handle is retractable and a part or all of the support mechanism is retracted by retracting the handle.

36. A load-carrying device according to claim 21, wherein the load-carrying device is a suitcase having a shell attached to the main frame.

37. A load-carrying device according to claim 21, wherein the load-carrying device is a hand truck having a load support platform connected to the main frame.

38. A load-carrying device according to claim 21, wherein the device has a weight that can be pulled by a person.
